(19) United States
(12) Patent Application Publication
(10) Pub. No.: US 2018/0213729 A1
(43) Pub. Date: Aug. 2, 2018

(54) LIGHT FIXTURE FOR A GREENHOUSE

(71) Applicant: LUXAZ, Brossard (CA)

(72) Inventor: Claude LEBEL, Saint-Bruno-de-Montarville (CA)

(21) Appl. No.: 15/850,760

(22) Filed: Dec. 21, 2017

Related U.S. Application Data
(60) Provisional application No. 62/437,843, filed on Dec. 22, 2016.

(51) Int. Cl. A01G 9/20; F21K 9/20; F21V 29/56; F21S 8/04; F21V 33/00

(52) U.S. Cl. CPC A01G 9/20; F21K 9/20; F21W 2131/40; F21S 8/043; F21V 33/006; F21V 29/56

(57) ABSTRACT

A light assembly (10) for installation in a greenhouse comprises a light unit (30) and at least one light fixture (20) mounted thereto. The light unit (30) comprises a light unit body comprising a light mounting structure (200), and a plurality of light sources mounted to the light unit body along a row. The light fixture (20) comprises a light fixture body comprising a light mounting structure (100) for mounting a light unit (30) thereto with thermal connection therebetween, a first passage (140) comprising an entry port (142) and an exit port (144) for a cooling fluid to circulate to dissipate heat conducted from the light unit (30) into the light fixture (20), a second passage (150) comprising an entry port (152) for receiving vaporizable compounds, and vaporization ports (160) fluidly connected to the second passage (150).

### CROSS-REFERENCE TO RELATED APPLICATION

This application claims priority from U.S. patent provisional application 62/437,843 filed Dec. 22, 2016, the specification of which is hereby incorporated herein by reference in its entirety.

### BACKGROUND

### (a) Field

The subject matter disclosed generally relates to light fixtures. More particularly, the subject matter disclosed relates to light fixtures for greenhouse environments.

### (b) Related Prior Art

In the field of horticulture, the practice of in-house and enclosed plant cultivation has intensely developed over the last decades. The cultivation of vegetables and other plants in greenhouses is nowadays a real commercial field. The amounts invested in this field have exploded during this time and remains an important field of the economy.

Numerous improvements have been the objects of development during the last decades, including the structure of greenhouses, the collection and use of greenhouse gases, the improvement and automation of greenhouse systems and greenhouse components, design of greenhouse systems of different scales to adapt to commercial activities as to hobby activities, the design of greenhouse systems as domestic appliances, the development of products specific to greenhouse uses, etc.

There is therefore an obvious need for continuous improvement in this field.

### SUMMARY

According to an embodiment, there is disclosed a light fixture adapted to receive a light unit and for installation in a greenhouse, the light fixture comprising:

a light mounting structure for mounting the light unit thereto with thermal connection between the light mounting structure and the light unit;

a first passage comprising an entry port and an exit port, wherein the first passage is for receiving a cooling fluid which circulates therethrough, and wherein the cooling fluid dissipates heat conducted from the light unit to the light mounting structure;

a second passage comprising an entry port adapted to receive a vaporizable compound; and

vaporization ports fluidly connected to the second passage for vaporizing the vaporizable compound into the greenhouse.

According to an aspect, the first passage and the second passage are oriented parallel to each other.

According to an aspect, the light fixture further comprises a vaporization component mounted to one of the vaporization ports.

According to an aspect, the light fixture further comprises a cap releasably mounted to one of the second passage and the vaporization ports.

According to an aspect, the light fixture further comprises a third passage fluidly connecting the vaporization ports with the second passage, wherein the second passage is oriented longitudinally and the third passage is oriented transversally.

According to an aspect, the second passage and the third passage form cylindrical shapes of a second and a third diameter respectively, and wherein the second diameter is greater than the third diameter.

According to an aspect, the light fixture further comprises a body having two end faces relative to its longitudinal orientation, wherein the end faces comprise fixation holes for securing additional or alternative components to the light fixture.

According to an aspect, at least one of the entry port of the first passage, exit port of the first passage, the entry port of the second passage and the ventilation ports are threaded.

According to an aspect, the second passage connects a first one of the end faces with a second one of the end faces.

According to an aspect, the light fixture further comprises a channel extending between the end faces, wherein the channel is for slidably mounting at least one of the light unit, and a mounting component to the light fixture.

According to an aspect, the light fixture further comprises a bracket mounted to one of the end faces, wherein the bracket blocks access to the channel from the one of the end faces.

According to an aspect, the light fixture further comprises a top and sides, wherein the channel is located on the head or on the sides of the light fixture.

According to an aspect, the light mounting structure comprises a contact surface for complementary thermal connection with a contact surface of the light unit, and wherein the contact surface comprises longitudinal ridges extending at least one of inwardly and outwardly relatively to the light fixture, wherein the longitudinal ridges increase an area of contact between the contact surface of the light mounting structure and the contact surface of the light unit.

According to an aspect, the light fixture consists of a unibody.

According to an aspect, the unibody is one of casted and molded.

According to an aspect, the light fixture is made of one material from the group comprising: aluminum, aluminum alloy, metallic alloy, and thermally conductive plastic.

According to an aspect, the light fixture further comprises a body having two end faces relative to its longitudinal orientation, whereby each one of the two end faces is adapted to be connected to a corresponding one of two end faces of another light fixture, whereby the same cooling fluid circulates through both light fixtures.

According to an embodiment, there is describe a light assembly for installation in a greenhouse comprising:

a light unit comprising:
a light unit body comprising a light unit mounting structure;
a plurality of light sources mounted to the light unit body; and
   a light fixture comprising:
a light fixture body comprising a light mounting structure for mounting the light unit thereto with thermal connection therebetween;
a first passage comprising an entry port and an exit port, the first passage being for cooling fluid to circulate, wherein the cooling fluid is dissipating heat conducted from the light unit into the light mounting structure;
a second passage comprising an entry port adapted to a receive vaporizable compound; and
vaporization ports fluidly connected to the second passage and for vaporizing the vaporizable compounds into the greenhouse.

According to an aspect, the light assembly has a longitudinal orientation, and wherein the light fixture comprises longitudinal mounting members for mounting the light unit to the light fixture.

According to an aspect, the light unit comprises two light units, and wherein the two light units are mounted to the same longitudinal mounting members along a single row.

### BRIEF DESCRIPTION OF THE DRAWINGS

Further features and advantages of the present disclosure will become apparent from the following detailed description, taken in combination with the appended drawings, in which:

FIG. 1 is a perspective view of a light assembly comprising a light fixture to which a LED light unit is mounted in accordance with an embodiment;

FIG. 2 is a bottom perspective view of a light fixture with a LED light unit mounted thereto in accordance with an embodiment;

FIG. 3 is a top perspective view of the light fixture of FIG. 2;

FIG. 4 is a bottom exploded view of the light fixture of FIGS. 2 and 3;

FIG. 5 is a top perspective view of a light fixture with a LED light unit mounted thereto in accordance with an embodiment;

FIG. 6 is a bottom perspective view of the light fixture of FIG. 5;

FIG. 7 is a bottom exploded view of the light fixture of FIGS. 5 and 6;

FIG. 8 is a schematic of a greenhouse installation using a light fixture accordance with an embodiment.

It will be noted that throughout the appended drawings, like features are identified by like reference numerals.

### DETAILED DESCRIPTION

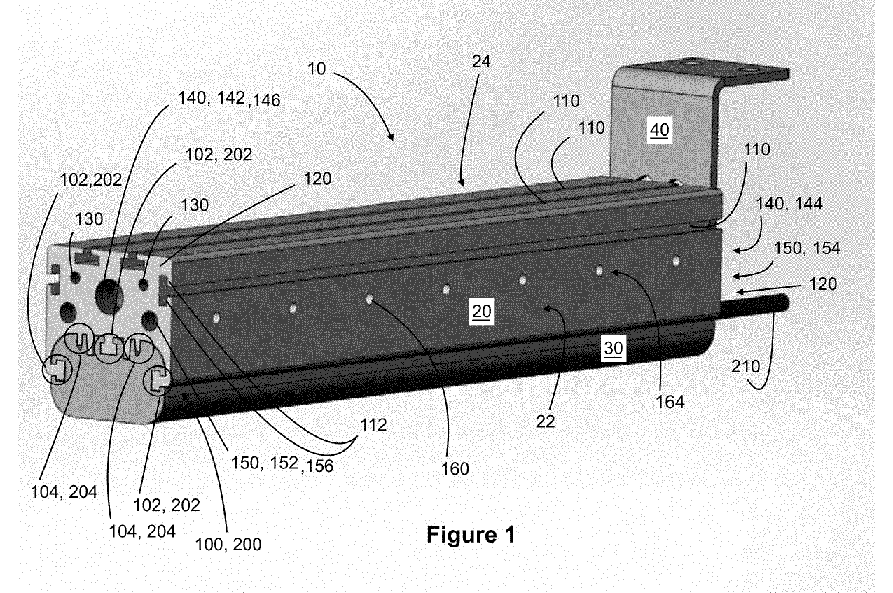

Referring now to the drawings, and more particularly to FIG. 1, a light assembly 10 for installation in a greenhouse is illustrated. The light assembly 10 is adapted to be installed in a greenhouse wherein plants are grown. Typically, the type of greenhouses in which the light assembly 10 is installed involves illuminating the plants at least sometimes with artificial light to compensate from some lack of natural light, the lack of some light frequencies from natural light, etc. Since the greenhouse consists in a more or less closed environment, the growth of greenhouse plants involves providing the plants with elements that cannot be naturally provided (or with difficulty) to the plants, such as water, and minerals to enrich the soil. In addition, additional products such as fertilizer, pesticide and herbicide are typically provided to the plants to promote their growth. Accordingly, greenhouses are highly controlled environments where many parameters and processes need to be controlled and to be performed to achieve the best plant growth and accordingly the best harvest possible.

The illustrated light assembly 10 is adapted to be hung from the ceiling (or other structure) of the greenhouse over the plants and to respond to a series of needs associated with the growth of plants in greenhouses. By limiting the number of components hung over the plants, and thereby the cover area these components define over the plants that limits the natural light reaching the plants, the light assembly 10 helps decrease the amount of artificial light necessary for the growth of the plants, decrease the complexity of the solution required for the greenhouse, and increase the productivity of the greenhouse.

Back to FIG. 1, the light assembly 10 comprises a light fixture 20 and a LED light unit 30.

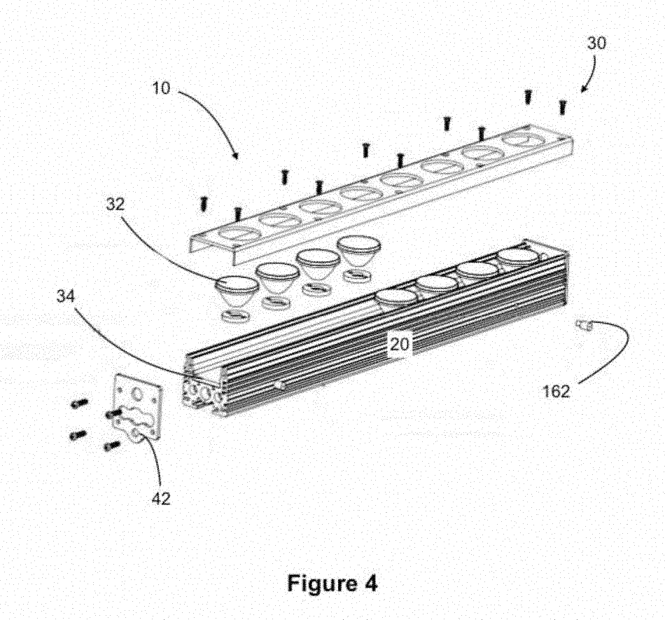

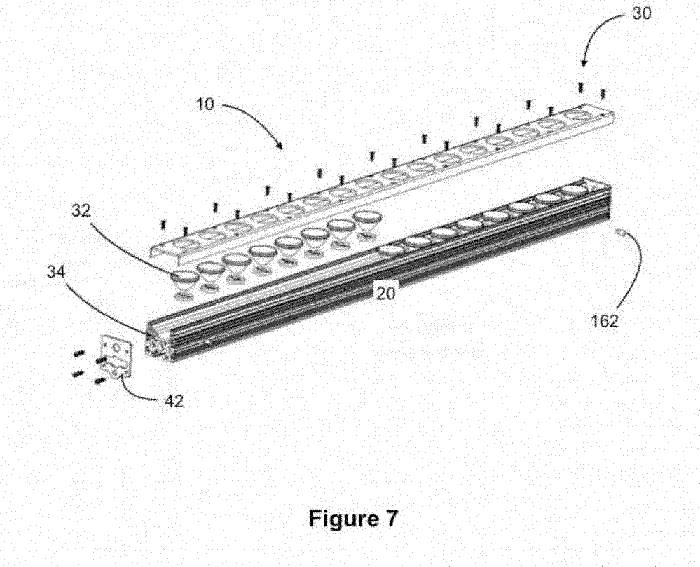

According to an embodiment, the light source of the LED light unit 30 consists in a series of LEDs 32 (Light Emitting Diodes, see particularly FIGS. 4 and 7) mounted in a housing, adapted to be mounted to a light fixture 20 and electrically connected through an electric cable 210 to a power source. The LEDs 32 may consist in LEDs 32 of different colours, and LEDs 32 capable of emitting different light frequencies. The LEDs 32 may be controllable so that the illumination of the plants may be adapted between lighting sessions based on the identified needs of the plants. Furthermore, the parameter of illumination may be adapted for different locations in the greenhouse for adapting the light assembly 10 to the particular needs based on the nature of the plants located in these particular locations or the better or worse conditions facilitating or hindering the natural light to reach these locations.

The light fixture 20 and the LED light unit 30 are mounted together through complementary light mounting structures 100, 200. The light mounting structure 100, on the light fixture 20, comprises a plurality of longitudinal mounting members 102 featuring ribs, lips and/or grooves. The light mounting structure 200, on LED light unit 30, comprises an equal number of, and accordingly located, cooperating longitudinal mounting members 202 featuring complementary shape(s) to the cooperative longitudinal mounting members 102. The LED light unit 30 can be secured to the light fixture 20 by sliding longitudinally the LED light unit 30 inwardly relatively to the light fixture 20 with the longitudinal mounting members 102 of the light fixture 20 being aligned with the cooperative longitudinal mounting members 202 of the LED light unit 30. The light mounting structures 100, 200 further feature a plurality of complementary ridges 104, 204 which define contact surfaces 115, 215 that increases the area of the contact surfaces 115, 215 between the LED light unit 30 and the light fixture 20, thereby improving the heat transmission from the LED light unit 30 to the light fixture 20.

According to an embodiment, thermally conductive lubricant is used to ease the sliding of the contact surfaces 115, 215 against each other and further improve thermal conduction from the contact surface 115 to the contact surface 215.

According to an embodiment, the light fixture 20 as a length capable or mounting more than one LED light units 30 thereto. According to an embodiment, the LED light units 30 are mounted in an end-to-end fashion. According to embodiments, the LED light units 30 may be disposed “head to head” or “head to feet” to set the electric cables is specific orientations. The LED light units 30 disposed end-to-end may remain with a space in-between or may be abutted against each other. The LED light units 30 disposed end-to-end may remain with a space in-between or may be abutted against each other.

According to an embodiment (not shown), a plurality of LED light units 30 are mounted together on a light fixture 20 in parallel to each other. The light fixture 20 comprises a plurality of light mounting structures 100 distant and parallel to each other for mounting the LED light units 30 thereto. According to embodiments, the LED light units 30 may be disposed in the same direction, thus with their “heads” pointing in the same direction, or “head to feet”. Selection of one versus the other may be used to set the electric cables is specific orientations, e.g. in the same direction, all inwardly or all outwardly. The distance between two light mounting structures 100 may be set based on needs, thermal management, or based on other considerations.

Now returning to FIG. 1, the light fixture 20; the light fixture 20 comprises on its top face and its side faces a series of channels 110. The channels 110 are for securing the light fixture 20 and more precisely for hanging the light fixture 20 from the ceiling of the greenhouse, or from another structure such as a rigid grid structure (not shown) installed over the plants. Such a grid-shaped structure is typically adapted for hanging such components therefrom, and for securing electric cables and tubing dedicated to distributing water and such for instance. Each channel 110 comprises a pair of lips 112 located at a given distance from the floor of the channel 110 and extend inwardly. The lips 112 define, for each channel 110, an opening having a narrower width. Thus, each channel 110 defines a T-shaped longitudinal groove wherein a part of a mounting/hanging component (not shown) secured to the ceiling or grid structure that has a wider head relatively to the size of its body (e.g., a bolt-shaped element) may have its head sled in the channel 110. According to an embodiment, the hanging components consist in cables attached at one end to the ceiling or grid structure and that have at the other end a bolt-shaped head. Furthermore, typically, four (4) or more hanging components are secured to the channels 110 of the light fixture 20 on its top side; the mounting hanging components being grouped in pairs disposed side by side in different channels 110 located on the top 24 of the light fixture 20, the pairs being mounted distant from each other to provide stability to the hung light fixture 20. The channels 110 located on the sides 22 of the light fixture 20 are typically used for positioning the light fixture 20, pulling the light fixture toward one side direction, and mounting complementary components such as guiding structures (not shown) relative to vaporization elements (not shown).

According to an embodiment, locking components (not shown) are sled into the channels 110 along the hanging component, at least in outward locations with respect to the hanging components, for hindering the course of the hanging components toward the exit of the channels 110. The locking components typically comprise releasably securing mechanisms, such as a piece adapted to be inserted into a channel 110 comprising a threaded hole and a bolt, allowing to individually lock the locking components in place in the channels 110 and thus preventing them to slide once locked. According to an embodiment, locking the locking components in place comprises turning the bolt such that its end distant from its head presses against the floor of the channel 110 and a portion of the locking components abuts against an inner area of the lips 112.

According to embodiments, alternative solutions to lock the head of the hanging components are used, integral to or distinct from the hanging components. According to embodiments, the locking components may comprise bias parts pressing against a surface of the channel 110 upon inserting and thus operating as an auto-locking feature.

Now returning to FIG. 1, the light fixture 20; the light fixture 20 comprises end faces 120. The end faces 120 are located at each end of the light fixture 20 according to its longitudinal orientation. Securing the light fixture 20 with the LED light unit 30, or with hanging components involves sliding the LED light unit 30 or the hanging component beginning at one end face 120 of the light fixture.

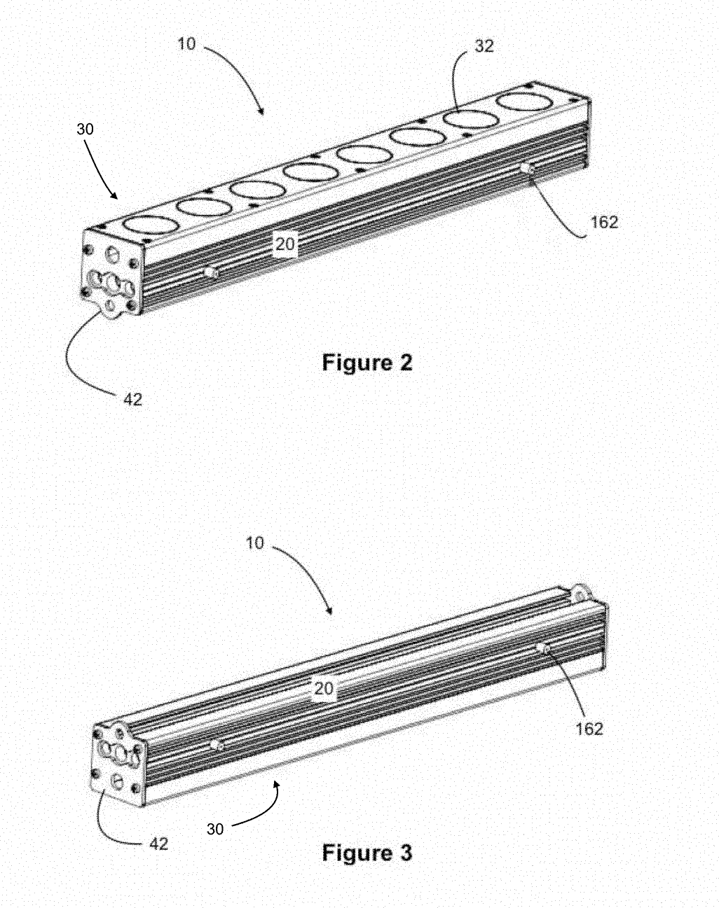

The light fixture comprises fixation holes 130 on each end face 120 of the light fixture 20. The fixation holes 130 are for securing additional or alternative components to the light fixture 20. Examples of such components comprise an hanging bracket 40 to rigidly secure the light fixture 20 to a structure, a locking bracket 42 (see FIG. 2) to block channels 110 at one of the end faces 120 preventing the hanging components to slide out of the channels 110, etc. Typically, the fixation holes 130 are threaded holes having a depth and a diameter adapted to the material in which the light fixture 20 is made such as the expected weight of the light fixture 20, and to the requirements specific to the components to be secured thereto (e.g. LED light unit 30) and circulating therein (e.g., cooling liquid, vaporizable compounds, etc.).

Still referring to FIG. 1, the light fixture 20 comprises a cooling passage 140, typically of a cylindrical shape, extending longitudinally throughout the light fixture 20 between the end faces 120, thereby comprising an entry port 142 and an exit port 144. The cooling passage 140 is typically a cylindrical passage ending with a threaded portion at each one of the entry port 142 and the exit port 144. The cooling passage 140 extends substantially above the light mounting structure 100, with the portion of the light fixture 20 between the cooling passage 140 and the light mounting structure 100 (a.k.a. a portion of the body of the light fixture 20) being adapted for heat exchange between the two. Accordingly, heat produced by the LED light unit 30 is transmitted to the light fixture 20 through the contact surfaces 115, 215 contacting the light mounting structures 100, 200, and dissipated through the light fixture 20 away from the LED light unit including towards the cooling passage 140. The heat transmitted to the wall 146 of the cooling passage 140 is transmitted to the cooling liquid (not shown) circulating in the cooling passage 140, thereby cooling the whole light fixture 20. By cooling down the light fixture 20 through a cooling passage 140 located substantially at the heart of the light fixture 20, every part of the light fixture 20 is efficiently cooled down.

The light fixture 20 further comprises one or more vaporization passages 150, typically of a cylindrical shape. In the described embodiment, two (2) vaporization passages 150 are present, one closer to each side 22 of the light fixture 20 than the cooling passage 140. The illustrated vaporization passages 150 consists in a circular passage extending longitudinally throughout the light fixture 20 between the end faces 120. However, in other embodiments, alternative configurations may be used for a vaporization passage 150. The vaporization passages 150 features an entry port 152 herein illustrated as located on one end face 120 of the light fixture 20. The vaporization passages 150 may also feature an exit port 154 located at the opposite end face 120 (thus hidden) of the light fixture 20. The exit port 154 may be used to connect the vaporization passages 150 to the entry port 152 of another vaporization passage 150, or may be blocked based on desired configuration. Typically, the entry port 152 and the exit port 154 are threaded to ease installation of connections (e.g., adaptors for tubing) or a cap.

The light fixture further comprises vaporization ports 160 each fluidly connected to a vaporization passage 150. The vaporization ports 160 are located typically at equidistant locations along the length of the light fixture 20 and substantially at the same height as the vaporization passage 150 they are connected to for minimizing the length of the necessary transversal passages 164, typically of a cylindrical shape, between the vaporization port 160 and the vaporization passage 150 in the light fixture 20. The vaporization ports 160 are for vaporizing or dispersing into the greenhouse environment a vaporizable compound circulating or fed to the vaporization passage 150.

According to an embodiment, the vaporization ports 160 are holes of predetermined shape and dimension to efficiently vaporizing the vaporizable compounds with the desired characteristics, for example flow, size of droplets, etc.

According to an embodiment, the vaporization ports 160 are threaded for securing the vaporization components 162 such as tubing, vaporization tips or a combination thereof. According to an embodiment, the vaporization ports 160 consist of inner threaded ports with the outer wall of the vaporization component 162 also threaded. According to an embodiment, the vaporization ports 160 consist in a protrusion (now shown) extending outwardly from the side face of the light fixture 20, with an outer wall which is threaded to screw a vaporization component 162. According to an embodiment, the protrusion features an outer wall on which the vaporization component 162 may be secured using a collar or another securing element. According to an embodiment, the vaporization components 162 are maintained in place mounted to the vaporization ports 160 by friction or compression, or a combination of the two.

Accordingly, the vaporization components 162 are adapted to vaporize the vaporizable compound according to a desired characteristics or configuration (flow, shape of the droplets, location of the vaporization which may for instance have the vaporization tip below the level of the LED light unit 30 and thereby preventing the vaporizable compound to be vaporized over the LEDs 32, etc.). According to an embodiment, the vaporization components 162 are releasably secured to the light fixture 20, so one component may be replaced with a new one when a different configuration is desired.

According to any of the above embodiments, a cap (not shown) may be secured over one or more of the vaporization ports 160 to block the vaporization port 160, and thereby to prevent loss of pressure and/or vaporizing fluid for downstream vaporization ports 160. That cap, based on the embodiment, may be screwed, secured with a collar or alike, or pressed in place with its body compressed to enter the vaporization port 160 so that the expending characteristics of the cap material is thereby preventing the cap from being expulsed from the vaporization port 160 by the pressurized content of the vaporization passage 150.

According to an embodiment, the light fixture 20 is made of material having elevated thermal conductivity and thermal dissipation characteristics. According to an embodiment, the material used for the light fixture 20 is either aluminium or an aluminum alloy. According to an embodiment, the material used for the light fixture 20 is another metallic alloy. According to an embodiment, the material used for the light fixture 20 is a thermally conductive plastic such as the CoolPoly® thermally conductive plastic made by Celanese® (http://www.coolpolymers.com/). According to embodiments, and particularly metal-made light fixtures 20, the light fixture 20 consists in a unibody casted/unitary body and afterwards potentially machined (for example for parts to be threaded). According to embodiments, and particularly plastic-made light fixtures 20, the light fixture 20 consists in a unibody molded and afterwards potentially machined (for example for parts to be threaded).

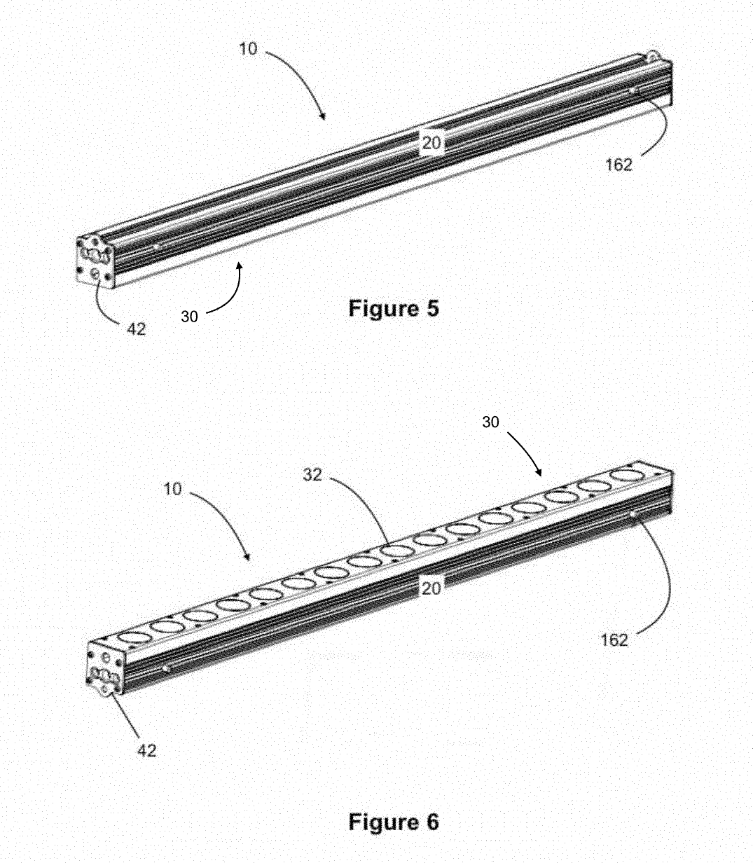

FIGS. 2 to 5 illustrate an embodiment of the light fixture 20 wherein the LED light unit 30 comprises eight LEDs 32 mounted side-by-side thereto along a single row. FIGS. 6 to 9 illustrate an embodiment of the light fixture 20 wherein the LED light unit 30 comprises sixteen (16) LEDs 32 mounted side-by-side thereto along a single row. These embodiments are provided as examples of alternative dimensions of the light fixture 20. FIGS. 4 and 7 illustrate the use of an isolating material, namely silicon, between the LED light unit 30 and the light fixture 20. FIGS. 2 to 7 further illustrate an embodiment of the LED light unit 30 that, rather than being sled into place to be mounted to the light fixture 20, comprises a twice-folded flat material with openings for the LEDs 32. The LED light unit 30 is fastened to the light fixture 20 using screws or alternative fastening means.

Alternative configurations of light fixtures 20 and complementary LED light unit 30 are also available to allow mounting of the LED light unit 30 to the light fixture 20 that respect the aimed thermal conductivity efficiency. Therefore, one must note that the described features of the light fixture 20 and the LED light unit 30 adapted to mount one to the other are described for teaching purposes and are not intended to limit the scope of the protection.

According to alternative embodiments adapted for specific parameters, alternative configurations of cooling passages 140 and vaporization passages 150 are available.

According to one first such alternative embodiment (not shown), the light fixture 20 comprising a single vaporization passage 150 located above dual cooling passages 140. The vaporization passage 150 is thermally better isolated from the heat source that is the LED light units 30. The walls 146 of the cooling passages 140 offer an increase surface for thermal dissipation into the cooling fluid, thus less heat reaches the wall 156 of the vaporization passage 150. The vaporization ports 160 are fluidly connected to the vaporization passage 150 through longer transversal passages 164. Further, with dual cooling passages 140, a U-shaped tubing can be connected at one end of the light fixture 20 for the cooling fluid to travel in one direction in one of the cooling passages 140 and travels in the other direction in the other cooling passage 140.

According to one second such alternative embodiment (not shown), the light fixture 20 features dual cooling passages 140 that are located closely above each of the two vaporization passages 150. This configuration is well adapted for higher operating-temperature vaporization compounds. The light fixture 20 further features relatively short transversal passages 164.

According to one third such alternative embodiment (not shown), the light fixture 20 is adapted to mount two LED light units 30 in a parallel configuration. The light fixture 20 features three cooling passages 140 adapted to fluidly connected together by tubing close to the entry ports 142 and exit ports 144. The light fixture 20 may comprise a single vaporization passage 150 could be oversized relatively to the cooling passages 140. In this exemplary embodiment, transversal passages 164 extend from the vaporization passage 150 to fluidly connect to vaporization ports 160 located on both sides of the light fixture 20.

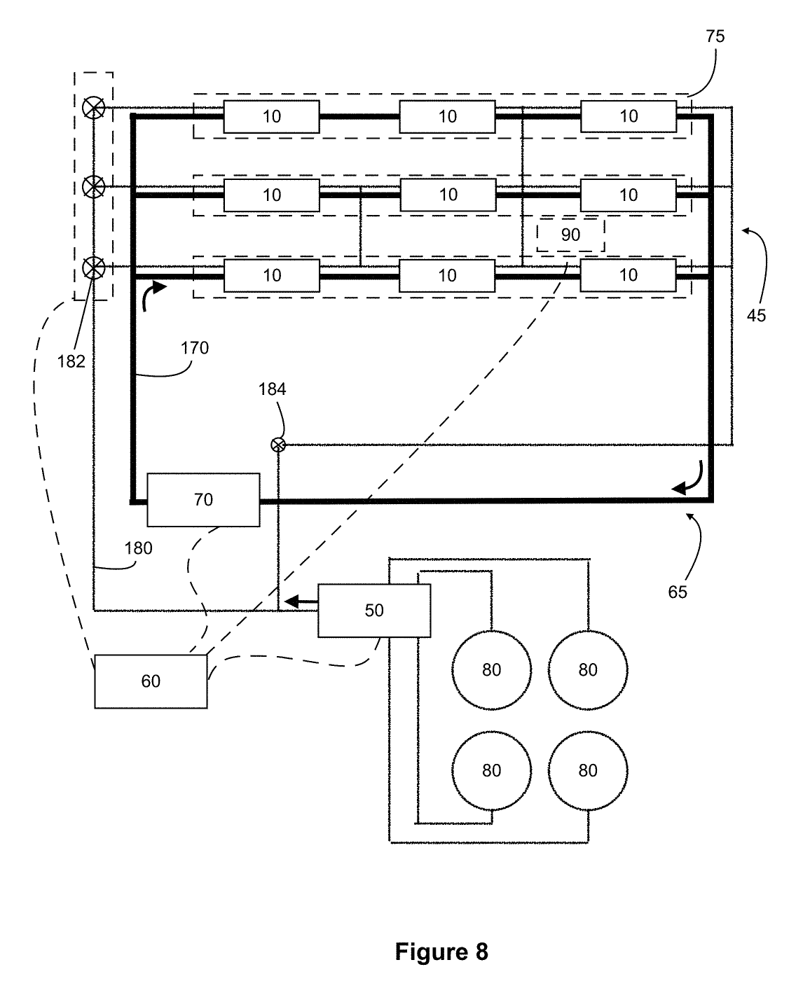

Now referring to FIG. 8, an embodiment of a greenhouse system using the present light assembly 10 comprises a cooling circuit 65. A plurality of light assemblies 10 are disposed in the example in serial connection and in parallel connection. In the illustration, the three light assemblies 10 of each row 75 are in serial connection, while each of the rows 75 of light assemblies 10 may be considered in parallel connection with each other.

In the illustrated embodiment, the wide lines schematically illustrate the cooling tubing 170 in which cooling fluid circulates from a cooling system 70 to the different light assemblies 10 and back to the cooling system 70 again. Having the rows in parallel connection and multiple light assemblies per row 75, the cooling fluid flows in the left light assembly 10 of one row 75, to the central light assembly 10 and to the right light assembly 10 of the same row 75 before flowing back to the cooling system 70. The same principle applies for the light assemblies 10 of the other two rows 75.

For illustration purpose, the cooling fluid circulate in a clockwise direction, flowing through all of the light assemblies 10 before flowing back to the cooling system 70. Since the cooling fluid circulates from and back to the cooling system 70 within a closed-loop cooling circuit 65, the cooling system 70, the light assemblies 10 and the cooling fluid circulating tubing are part of the cooling system that forms a closed circuit.

For illustration purpose, the cooling system 70 combines heat-exchange functions and pump functions.

In the illustrated embodiment, the cooling system 70 is controlled by a controller 60. The controller 60, based on manual commands or on programming and input signals from environmental detectors 90 (e.g. greenhouse thermometer(s), light assembly thermometers, etc.) and/or internal detectors (not show, e.g. internal cooling system thermometer(s), control sensor, etc.) controls the temperature and/or flow of cooling fluid flowing in the light assemblies 10 to dissipate the heat produced by the LED light units 30 and to keep both the light fixture 20 and the greenhouse within a desired temperature range.

The system further comprises a vaporization system 45. The vaporization system 45 comprises a plurality of reservoirs 80 containing typically different vaporizable compounds. The reservoirs 80 are fluidly connected to a pump 50. The pump 50 is connected to a circuit of vaporization tubing 180 fluidly connecting the pump 50 to the light assemblies 10.

For illustration purpose, the vaporization tubing 180 downstream the pump 50 divides in two directions: one to the left of the light assemblies 10 and one to the right of the light assemblies 10. On the left portion, the vaporization tubing 180 divides towards three tubing 180 that feed with vaporizable compound the three left light assemblies 10 of the three rows 75. The right side features a similar circuit. Further, tubing 180 connecting the rows 75 in-between light assemblies 10 are illustrated as vertical lines of tubing 180 that may be used to level the pressure and flow between the different light assemblies 10 and/or the different rows 75 of light assemblies 10.

For illustration purpose, the vaporization system 45 comprises valves 182, 184 for allowing, controlling and/or interrupting the flow of vaporizable compound in the light assemblies 10. One must understand that the number and locations of the valves 182, 184 are for illustration purpose only. Typically, valves 182, 184 are used to determine which of the light assemblies 10 will be fed with vaporizable compounds. The vaporization circuit of the vaporization system 45 is typically configured to level the pressure and flow between the operating light assemblies 10, so that the vaporizable compound circulates according to the desired flow in the desired direction. The valves 182, 184 that are illustrated may be manual valves, or remotely controllable valves under control of the controller 60.

For explanation purpose, if the valve 184 is closed and all valves 182 are open, thus no vaporizable compound flowing through the bottom-right section of the tubing 180. Accordingly, one should understand that the vaporizable compound would be fed to the far-left light assemblies 10 on their left side (thus their entry port being on the left side) with part of the vaporizable compound potentially flowing out of these same light assemblies 10 on the right side (thus their exit port being on the right side). Flow directions of vaporizable compound in the other light assemblies 10 would depend on pressure on the exit ports of the three far-left light assemblies 10, thus on configuration of used vaporization ports 160, e.g. pressure, flow exiting through, etc.

Further, according to embodiment, it is worth mentioning that the light assemblies 10 may be part of either a manual system or a more automated one, or even a fully automated greenhouse system. Automation of the greenhouse system involves the use of a controller 60 connected to the cooling system 70, the pump 50, valves 182, 184 located at different locations on the vaporization system 45 and controlling the nature and/or concentration of the vaporizable compound, the amount of vaporizable compound to pump in the vaporization system 45, the pressure applied to the vaporizable compound, controlling the light assemblies 10 fed by cooling fluid and/or by vaporizable compound, controlling the lighting and the light frequencies and colour used to light up plants according to different areas of the greenhouse, etc. The automated system may depend and/or respond to signals from detectors 90 such as thermometers associated with light assemblies 10, greenhouse environmental thermometers, air humidity sensors, soil humidity sensors, soil analysis components, cameras, light sensitive sensors, etc. The controller 60 may display information based on received signals and/or analysis of signals received from the detectors 90, and propose commands based on the detection signals. The controller 60 may trigger processes based on processing of the detection signals according to plant cultivation knowledge-based programming.

According to an embodiment (not shown), the light assemblies 10 are used in a vertical greenhouse environment. Accordingly, the light assemblies 10 are installed at different elevations substantially on top of each other to one side (or many sides) of a vertical greenhouse. According to an embodiment, the vertical greenhouse is mounted on a motorized vertical conveyor which moves the plants mounted thereto. For instance, the plants are moved up on one side of the vertical conveyor and moved down on the opposite side of the vertical conveyor. The light assemblies 10 are installed on one side of the vertical conveyor illuminating the plants, watering the plants and vaporizing other vaporizable compounds on the plants on that side of the vertical conveyor. When on the other side of the vertical conveyor, the plants are “sleeping” since they are in a rest mode.

The nature of the vaporizable compounds used in relation with the present light assemblies may comprise water, carbon dioxide, fertilizing products, herbicide products, and pesticide products. The nature of the vaporizable compounds therefore comprises water-soluble products and gaseous components that can be pumped into the plant growing environment.

According to an embodiment, the selection of the vaporizable compound(s) to use in the present vaporization system allows temperature sensitive products. By having a cooling fluid circulating in the light fixture 20, the present system allows to control the temperature of the wall(s) 156 of the vaporization passage 150, and thereby provides novel possibilities in the selection of the vaporizable compound(s) to vaporize as in the methods used to vaporized the selected product(s). It allows for instance to keep the vaporizable compound in a temperature range optimal for the efficiency of the vaporizable compound, or to use one vaporizable compound that would be instable in normal temperature and condition and that can now be kept in stable condition.

The nature of the cooling fluid used in relation with the present light assemblies may include cold water, nitrogen, standard cooling fluid such as Freon®, and other cooling fluids. According to one embodiment, the nature of the cooling fluid used to cool down the light assemblies 10 is selected so that a leak of the cooling fluid through the tubing of the cooling circuit would not present risks of arming the plants.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A light fixture adapted to receive a light unit and for installation in a greenhouse, the light fixture comprising:
a light mounting structure for mounting the light unit thereto with thermal connection between the light mounting structure and the light unit;
a first passage comprising an entry port and an exit port, wherein the first passage is for receiving a cooling fluid which circulates therethrough, and wherein the cooling fluid dissipates heat conducted from the light unit to the light mounting structure;
a second passage comprising an entry port adapted to receive a vaporizable compound; and
vaporization ports fluidly connected to the second passage for vaporizing the vaporizable compound into the greenhouse.

2. The light fixture of claim 1, wherein the first passage and the second passage are oriented parallel to each other.

3. The light fixture of claim 1, further comprising a vaporization component mounted to one of the vaporization ports.

4. The light fixture of claim 1, further comprising a cap releasably mounted to one of the second passage and the vaporization ports.

5. The light fixture of claim 1, further comprising a third passage fluidly connecting the vaporization ports with the second passage, wherein the second passage is oriented longitudinally and the third passage is oriented transversally.

6. The light fixture of claim 5, wherein the second passage and the third passage form cylindrical shapes of a second and a third diameter respectively, and wherein the second diameter is greater than the third diameter.

7. The light fixture of claim 5, further comprising a body having two end faces relative to its longitudinal orientation, wherein the end faces comprise fixation holes for securing additional or alternative components to the light fixture.

8. The light fixture of claim 1, wherein at least one of the entry port of the first passage, exit port of the first passage, the entry port of the second passage and the ventilation ports are threaded.

9. The light fixture of claim 7, wherein the second passage connects a first one of the end faces with a second one of the end faces.

10. The light fixture of claim 7, further the comprising a channel extending between the end faces, wherein the channel is for slidably mounting at least one of the light unit, and a mounting component to the light fixture.

11. The light fixture of claim 10, further comprising a bracket mounted to one of the end faces, wherein the bracket blocks access to the channel from the one of the end faces.

12. The light fixture of claim 10, further comprising a top and sides, wherein the channel is located on the head or on the sides of the light fixture.

13. The light fixture of claim 1, wherein the light mounting structure comprises a contact surface for complementary thermal connection with a contact surface of the light unit, and wherein the contact surface comprises longitudinal ridges extending at least one of inwardly and outwardly relatively to the light fixture, wherein the longitudinal ridges increase an area of contact between the contact surface of the light mounting structure and the contact surface of the light unit.

14. The light fixture of claim 1, wherein the light fixture consists of a unibody.

15. The light fixture of claim 14, wherein the unibody is one of casted and molded.

16. The light fixture of claim 14, wherein the light fixture is made of one material from the group comprising: aluminum, aluminum alloy, metallic alloy, and thermally conductive plastic.

17. The light fixture of claim 1, further comprising a body having two end faces relative to its longitudinal orientation, whereby each one of the two end faces is adapted to be connected to a corresponding one of two end faces of another light fixture, whereby the same cooling fluid circulates through both light fixtures.

18. A light assembly for installation in a greenhouse comprising:
a light unit comprising:
a light unit body comprising a light unit mounting structure;
a plurality of light sources mounted to the light unit body; and
a light fixture comprising:
a light fixture body comprising a light mounting structure for mounting the light unit thereto with thermal connection therebetween;
a first passage comprising an entry port and an exit port, the first passage being for cooling fluid to circulate, wherein the cooling fluid is dissipating heat conducted from the light unit into the light mounting structure;
a second passage comprising an entry port adapted to a receive vaporizable compound; and
vaporization ports fluidly connected to the second passage and for vaporizing the vaporizable compounds into the greenhouse.

19. The light assembly of claim 18, wherein the light assembly has a longitudinal orientation, and wherein the light fixture comprises longitudinal mounting members for mounting the light unit to the light fixture.

20. The light assembly of claim 19, wherein the light unit comprises two light units, and wherein the two light units are mounted to the same longitudinal mounting members along a single row.
